(19) United States
(12) Patent Application Publication
(10) Pub. No.: US 2010/0087937 A1
(43) Pub. Date: Apr. 8, 2010

(54) PORTABLE RECORDING DEVICE AND METHOD

(76) Inventor: David Christopher Tolson, Torquay (GB)

Correspondence Address: NIXON & VANDERHYE, PC, 901 NORTH GLEBE ROAD, 11TH FLOOR, ARLINGTON, VA, 22203, US

(21) Appl. No.: 12/530,261

(22) PCT Filed: Mar. 10, 2008
(86) PCT No.: PCT/GB2008/000816

§ 371 Date: Sep. 8, 2009

(30) Foreign Application Priority Data
Mar. 9, 2007 (GB) 0704581.8
May 4, 2007 (GB) 0708673.9
Sep. 10, 2007 (GB) 0717604.3

(51) Int. Cl. G06F 17/00

(52) U.S. Cl. 700/94

(57) ABSTRACT

A digital recording device (110) is portable and battery powered, designed particularly for operation with a guitar (115) and other stringed musical instruments (115a) whether fitted with magnetic pick-ups or not. The device (110) is sufficiently small and light weight to be carried by the musical instrument's jack socket (105) while being used. When not in use, the device is small enough to he considered “pocket sized”. The device uses a novel microphone (915) technique to receive and digitise acoustic signals produced by a musical instrument, or other source of analogue data, and store it numerically, for subsequent transfer in digital file format via a wireless connection (1055) and/or a Universal Serial Bus port. The device (110) offers a means of digitally recording music directly at the instrument, for subsequent playback or transfer to another device or piece of equipment.

The present invention relates to a portable recording device and a method of recording, particularly but not exclusively suitable for recording a musical instrument. It finds particular application in recording stringed instruments such as guitars.

It is known to use a cable to record from a stringed instrument onto recording equipment, including in some cases a personal computer. This might be either from a microphone (acoustic instrument) or from the amplifier of an electric instrument. However, in either case the instrument has to be near the recording equipment. Such arrangements do not allow recordings to be made in ad hoc situations such as live performances, unplanned sessions in non-studio situations, or travelling.

A two part recording arrangement is disclosed in U.S. Pat. No. 7,262,359 in which a small recording device with a microphone is mounted on a guitar by its jack plug. The device records sound into computer-readable files which can be downloaded to a computer. This arrangement allows recordings to be made without sophisticated recording equipment.

According to a first aspect of embodiments of the present invention, there is provided an instrument recording device adapted to be supported by an instrument during use, the device comprising:
i) a microphone for receiving sounds made by the instrument;
ii) an analogue to digital converter for converting received sounds into a digital signal;
iii) digital signal storage for storing the digital signal; and
iv) at least one output for outputting stored digital signals from the device,

the device further comprising a mounting arrangement for use in mounting the device on the instrument during use, the mounting arrangement housing the microphone.

For example, the mounting arrangement might comprise an electrical jack plug for mounting in the jack socket of an electrical instrument such as a guitar. This arrangement has particular advantages. It is not easy to get a good musical audio signal via a microphone from an instrument such as a guitar. By putting the microphone into the jack plug, the microphone can potentially be positioned inside the body of the instrument where it is much better positioned to pick up the sound of the instrument when played. It is also better protected from extraneous and conflicting noises and can reduce a distorting effect of resonance in the body of the instrument which can occur if the microphone is directly or indirectly mounted onto the body of the instrument.

In the case of an instrument which is generally played one string at a time, such as a violin, placing the microphone inside the body of the instrument can pick up enhancement of the audio signal by the body while at least substantially avoiding distortion caused by resonances.

Preferably, the microphone is an omnidirectional microphone. This can give a particularly good quality audio signal from inside the body of an instrument. A suitable mounting for such a microphone is a jack plug having apertures in its body adjacent the microphone to give all round audio reception as far as possible. For example, the jack plug might have a mesh section or have holes cut into its housing.

The at least one output for outputting stored digital signals may be provided for example by a connector such as a Universal Serial Bus (“USB”) plug socket which supports downloading to a personal computer or other equipment. However, the output, or indeed a second output, could equally be wireless, for instance based on infra red or Bluetooth technology. This allows delivery of audio recordings to any compatible device, such as for example a mobile telephone. More than one form of output can be provided and preferably the device also comprises a speaker or headphone socket so that it can be used for playback.

Preferably, the device further comprises a wireless input for receiving audio files from elsewhere and for instance from another such device. It then becomes possible for users to share what they have recorded quickly and easily. With existing Bluetooth technology, audio files could indeed be transmitted to and from any compatible device.

Preferably the device further comprises, in use, an electrical power storage device such as a battery. This might for example be received into a chamber or recess of the device to make the device fully and conveniently portable.

It is particularly convenient that the device should provide a graphical user interface (“GUI”) and at least one control for controlling operation of the device. For example, the GUI might be in the form of a liquid crystal display (“LCD”) panel and the at least one control might provide an input for user commands to the device, such as a record button. Optionally, there might be more than one control button, or indeed a keypad, for entering commands. For example, there might be buttons for receiving commands in relation to one or more of the following functions:
set up
record
file storage/retrieval (including playback and transmit/receive)

It would also be possible to download or playback recorded files by using software on a PC or similar equipment to control the download, rather than controlling it via the device itself. The GUI might then be replaced by some other visual indicator to keep the user apprised of what operation the device is currently performing when mounted on an instrument, such as one or more light emitting diodes (“LED s”) next to alphanumeric labels indicating available operations. However, because the device is versatile and relatively self-contained in that it can be used for recording, playback and transmission of recordings to other devices, it would usually be preferred that controls, generally including a GUI, are provided on the device itself.

Embodiments of the invention in its first aspect allow recordings to be made in a far wider range of situations than previously possible, with little or no preparation. With the emphasis on simplicity, embodiments of the invention can provide portable battery powered recording technology. With the guitarist and/or songwriter in mind, all the user may have to do is simply switch the instrument recording device on, navigate to “record”, pick up the guitar and begin. Once that ‘true moment of inspiration’ has been created, the functionality of the instrument recording device allows the user to capture and then save those ideas, for example simply at the press of a file storage button. Those ideas can later be played back and/or transferred to another device or to a software programme within seconds, for instance via a USB or wireless connection.

According to a second aspect of embodiments of the present invention, there is provided an instrument recording device adapted to be mounted on an instrument during use, the device comprising:
i) an input for receiving sounds made by the instrument;
ii) an analogue to digital converter for converting received sounds into a digital signal;
iii) digital signal storage for storing the digital signal;
iv) at least one output for outputting stored digital signals from the device;
v) a user interface; and
vi) a command processor for implementing commands input by a user via the interface

wherein the at least one output comprises a wireless output and the arrangement is such that the interface and command processor support wireless transmission of a stored digital signal, from the device.

The input may comprise a jack plug for receiving electromagnetic signals from a pickup already present on the instrument. Preferably, the input may instead or further comprise a microphone for receiving audio signals from the instrument. In preferred embodiments of the invention, the input comprises an input jack which also houses a microphone. In many instruments, such as electric guitars, the input jack is inserted to a position inside the body of the instrument. In such an arrangement, the microphone can then be carried by the jack plug to a position inside the instrument where the quality of the recording will be improved as described above.

Embodiments of the invention in its second aspect offer a self-contained and portable little device which is quite powerful in its different applications. Instead of being designed just as a pickup for capturing sound that will later be downloaded to conventional sound processing equipment, either specialised or as marketed for personal computers, the device allows sounds to be captured, played back immediately or sent to another portable device to be stored or played back. There is no need of a computer to listen to recorded sounds. The user can potentially for example capture a new melody, play it back and then transfer it to another device of the same type or to a mobile telephone.

Any feature described in relation to one aspect or to any one embodiment of the invention may be applied in relation to one or more other aspects or embodiments of the invention if appropriate. Inventive features of embodiments of the invention are as described above, or as set out in the claims hereto, or may instead be mentioned in the following description.

An instrument recording device will now be described as an embodiment of the present invention, by way of example only, with reference to the accompanying figures in which:

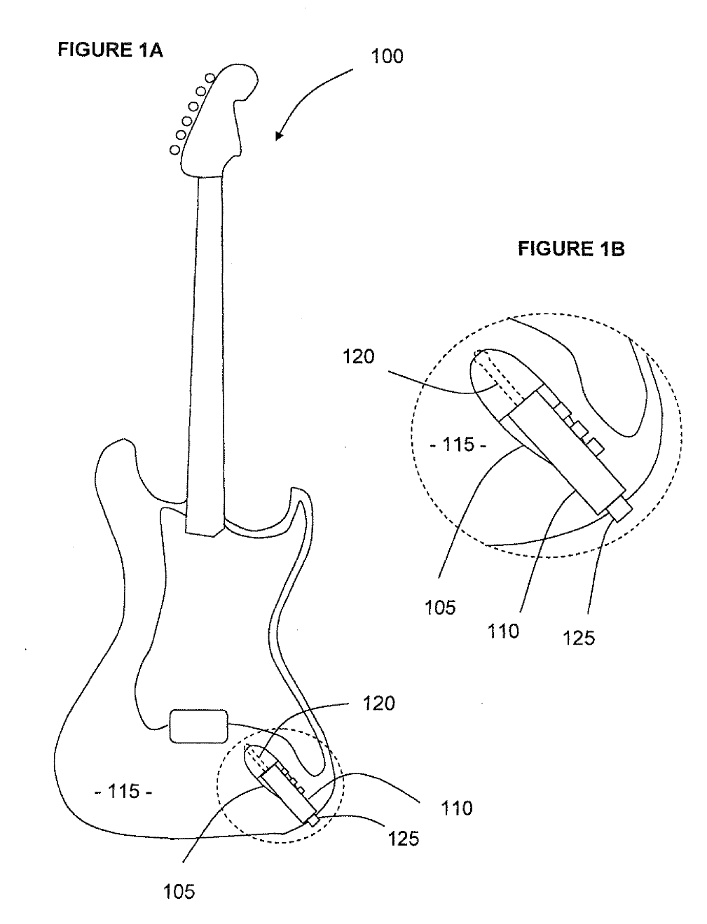

FIG. 1A shows in plan view an electric guitar of the type “Fender Stratocaster” (registered trade mark) with the device in operating position in the jack socket of the guitar;

FIG. 1B shows in larger scale the device and the jack socket of FIG. 1A, as ringed in dotted outline in FIG. 1A;

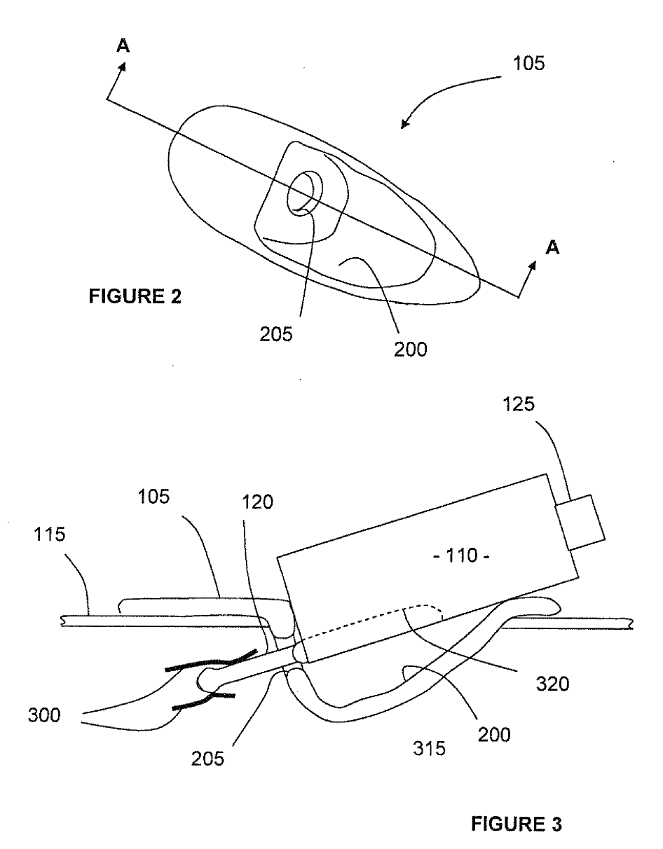

FIG. 2 shows in plan view the jack socket of FIG. 1A, without the device in place;

FIG. 3 shows a vertical cross section through the jack socket of FIG. 2, with the device in place;

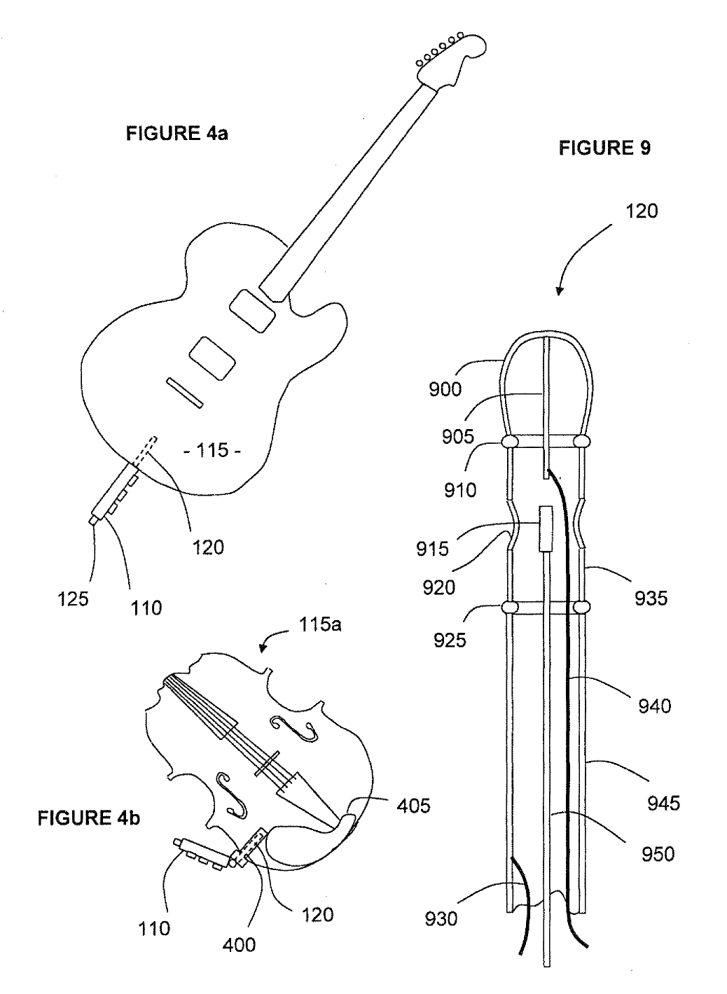

FIG. 4a and FIG. 4b show in plan view two different types of instrument with the device in place in differently arranged jack sockets;

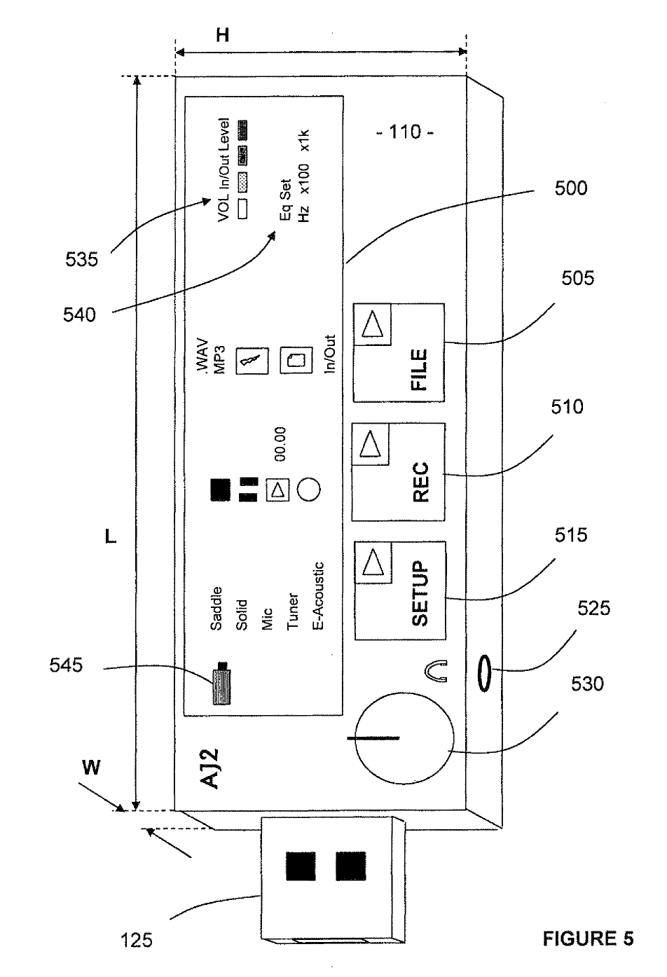

FIG. 5 shows, in quarter view from above, the body of the device;

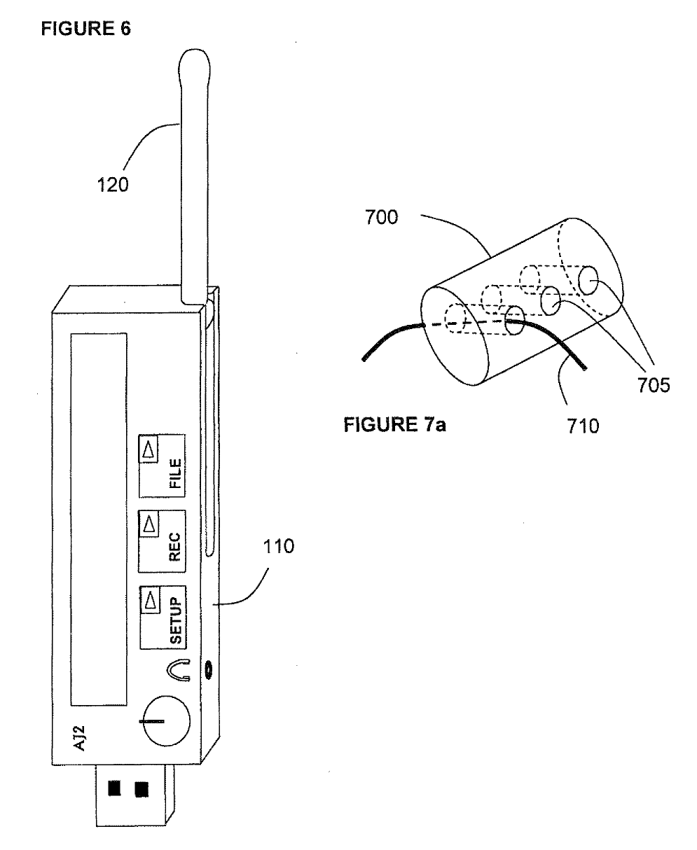

FIG. 6 shows, in quarter view from above, the body of the device with its jack pin in place;

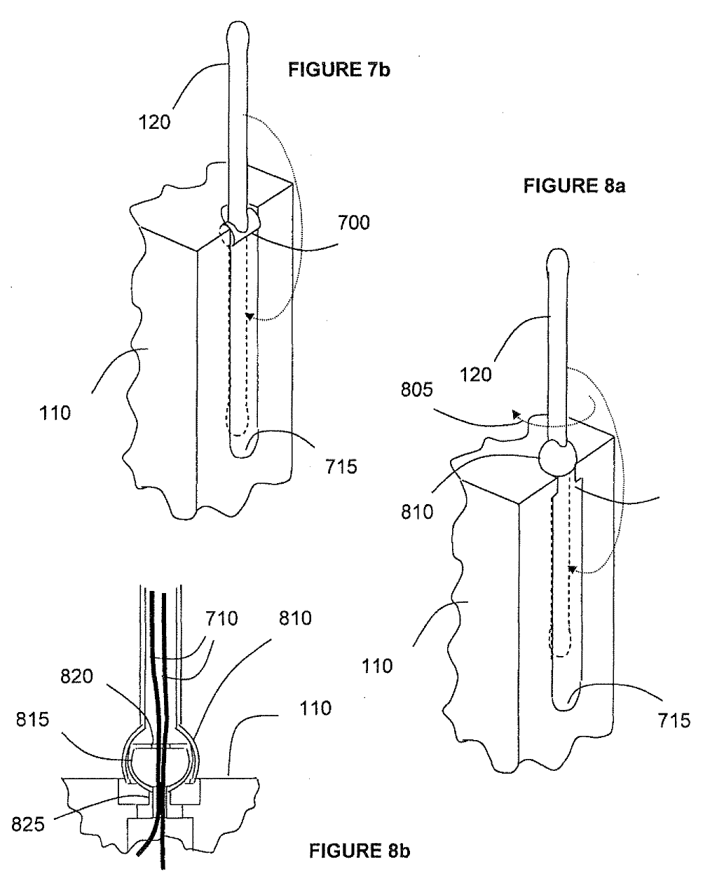

FIG. 7a shows, in three quarter view from the side, a drum part of a hinged coupling for mounting the jack pin on the body of the device;

FIG. 7b shows the operation of a hinged coupling incorporating the drum part of FIG. 7a in use of the device;

FIG. 8a shows an alternative hinged coupling based on a ball and socket joint;

FIG. 8b shows a cross section of the ball and socket joint of FIG. 8a;

FIG. 9 shows in cross section the jack pin of the device; and

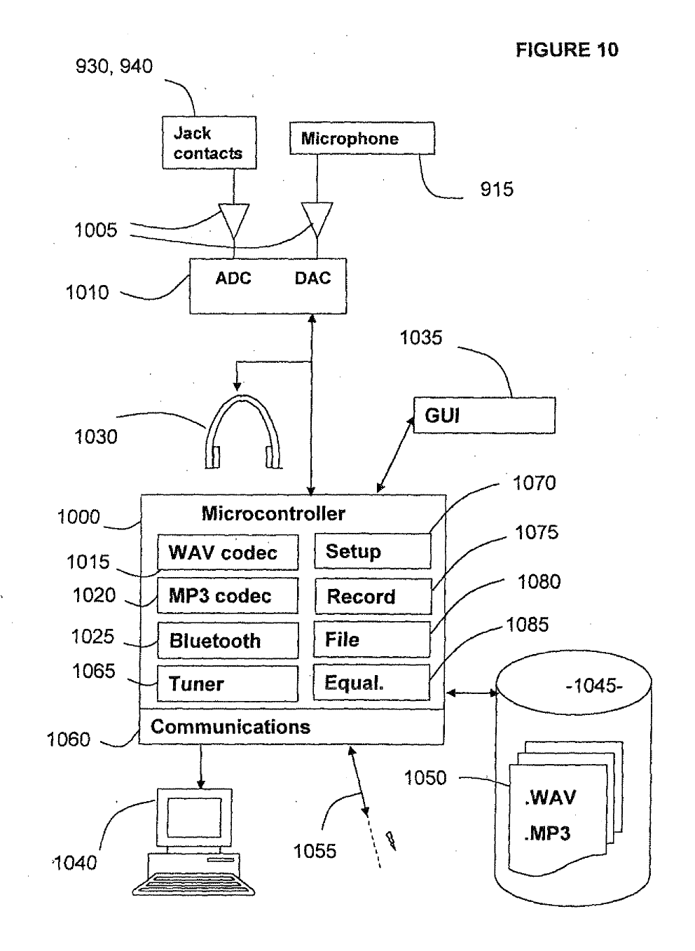

FIG. 10 shows a functional block diagram of software components of the device;

It should be noted that the figures are not drawn to scale.

Overview

Referring to FIG. 1A, an embodiment of the invention comprises a portable, battery powered, digital recording device 110, 120 designed specifically for operation with a guitar 100 and other stringed musical instruments. The device 110, 120 is adapted to work with a pickup (not shown) that might be provided with the instrument either at the time and point of original manufacture or, thereafter, by modification. Examples of suitable known pickups are transducers such as:
(a) magnetic, soundhole positioned;
(b) contact (permanently) fixed magnetic pickup(s); and
(c) piezo electric pickup(s).

The first two of these examples will operate with stringed instruments having electrically conductive strings while piezo electric pickups provide signal collection from non-metallic, i.e. nylon stringed (acoustic) instruments.

These known pickups convert the sound of the instrument into an analogue electrical signal and deliver it to a jack socket 105. The digital recording device 110, 120 is designed to incorporate an integrated jack plug 120 that fully inserts into a guitar's, and/or other stringed musical instruments', jack plug socket 105 to receive input (string resonated) analogue voltage signals from the pickup(s). Then, via an integrated microcontroller 1000, not shown in FIG. 1A but further described in relation to FIG. 10, the device 110, 120 converts the analogue signals into digitised real-time code. Utilising flash (registered trade mark) memory technology, the device 110, 120 converts the numerical data into .WAV and/or .mp3 file formats for storage or transmission. The device 110, 120 is also provided with a Universal Serial Bus (“USB”) plug 125 for connection to a personal computer (“PC”) and/or to an MP3 player for file transferral, editing and/or listening purposes. This can optionally be done at a later date than recording to memory in the device 110, 120. The USB plug 125 can also be used for recharging batteries of the device 110, 120 in known manner.

Referring to FIG. 1B, the digital recording device 110, 120 is sufficiently small and lightweight to be carried and supported by the musical instrument's jack socket 105 whilst being used. When not in use, the digital recording device 110, 120 is small enough to be considered “pocket sized”. FIGS. 1A and 1B show a Fender Stratocaster guitar and the jack socket 105 is of the usual type for such a guitar 100.

“.WAV” and “.mp3” file formats are mentioned above. These are references to known formats for audio data. For example, MP3 is a compression system for audio files which is a subsystem of the MPEG system developed by the Moving Picture Experts Group, called in full “MPEG audio Layer-3”. “.WAV” files are written in an audio format developed by Microsoft and IBM for storing raw audio on PCs. Embodiments of the invention are not limited to use with these formats and indeed other formats might be supported as well or instead.

The jack plug 120 may be a standard jack plug for receiving electromagnetic signals from a pickup already present on the instrument but in the embodiment of the invention being described here, it may further comprise a microphone 915 (not shown in FIGS. 1A or 1B) for direct audio pickup and this is further described below in relation to FIG. 9.

Mounting

Referring to FIGS. 2 and 3, the jack socket 105 of a Fender Stratocaster guitar 100 has a flat body portion that seats against the guitar 100. However, the body 115 of the guitar 100 has an aperture which receives a pocket of the jack socket 105 in the form of a tapered recess 200. The recess 200 has a steep wall at one end with an aperture 205 in it and it is this aperture 205 that receives the jack plug 120 of the digital recording device 110, 120. The jack socket 105 would more usually receive a jack plug connected to a cable and the shape of the tapered recess 200 is designed to allow insertion of such a jack plug, the end of the cable seating conveniently into the recess 200. Behind the aperture 205 with respect to the recess 200 are resilient contacts 300 for delivering the analogue electrical signals from a pickup as mentioned above. These contacts 300 make contact to the jack plug 120 in use, in known fashion.

The jack socket 105 of a Fender Stratocaster guitar 100 in plan view tapers from a width of about 1.8 cm across the position of the aperture 205 that receives the jack plug to a width of about 1.3 cm across the end of the recess 200 away from the aperture 205. Referring additionally to FIG. 5, the body 110 of the digital recording device 110, 120 has a width “W” of 1.0 cm, a height “H” of 2.5 cm and a length “L” of 7.0 cm. When seated in the jack socket 105 of a Fender Stratocaster guitar 100, the digital recording device is thus best oriented so that the width “W” seats into the recess 200 and the 2.5 cm height of the device 110 extends outwards from the recess 200, as shown in FIGS. 1B and 3. Additionally, the jack plug 120 itself is mounted asymmetrically in the end of the body 110 of the device, towards a side thereof. This allows the digital recording device 110, 120 to be mounted in the recess 200 without fouling any part of the musical instrument 100 or impeding in any way the playing of the instrument.

Other instruments having a jack socket of the Fender Stratocaster type include electric violins. For example, several violins produced by Bridge Violins Ltd have a similar type of recessed socket, these including the “Octave”, “Lyra 5 String”, “Tasman” and Aquila” (registered trade marks) models. These instruments are particularly compatible with embodiments of the present invention, being instruments usually played with a single string at a time. The mounting of the microphone actually inside the body of the instruments can allow it to pick up the enhancement of the sound provided by the body of the instrument.

Referring to FIG. 4a, in an electro-acoustic guitar of another type, the jack plug socket might be differently positioned and, in the guitar body 115 shown here, the jack plug 120 of the digital recording device 110, 120 is at the base of the guitar and runs in the same general direction as the strings. However, different instruments may present very different orientations.

Referring to FIG. 4b, a known jack socket 400 for mounting on the outside of a violin is the VNP1 socket produced by Yamaha Corporation of America. This is clamped to the body 115a of the violin adjacent the shoulder rest 405. A digital recording device 110, 120 having its jack plug 120 inserted into this socket 400 extends outward from the instrument and it may be preferable that a hinged coupling between the jack plug 120 and the body 110 of the device can be bent to avoid fouling the action of the instrumentalist. Hinged couplings for use in embodiments of the invention are further described below under the heading “JACK PLUG 120, MOUNTING”.

Graphical User Interface 500

Referring to FIG. 5, the body 110 of the device provides a graphical user interface 500 (“GUI”) and various controls. The controls include a power/volume button 530 and three keys, these being a setup key 515, a recording function key 510 and a file storage/retrieval and transfer key 505. There is also a headphone socket 525. At the end of the body 110 of the device away from the jack plug 120 (not shown in FIG. 5), there is the US$ plug 125.

The GUI 500 has three main areas, each dedicated to a scrollable menu for one of the function keys 505, 510, 515. Each function key 505, 510, 515 has a forward indicator (“arrow”) which can be operated to scroll through its respective menu and then the key itself can be depressed to make a selection. The menus for each key may be for example as follows:

Setup Key 515:

Saddle

Solid

Mic

Tuner

E-acoustic

These options are used to set the recording device 110, 120 to operate in a manner appropriate to different types of guitar (saddle, solid or electro-acoustic) and to turn on/off a microphone 915, further described below in relation to FIG. 9, or a tuner.

The tuning facility is of known type and allows a screen display to be used to achieve accurate tuning of the strings.

Recording Function Key 510:

Symbol representing “Stop”

Symbol representing “Pause”

Symbol representing “Start”, together with active counter

LED to show the recording function is active

File Storage Key 505:

.WAV

.MP3

Symbol (lightning flash as shown) representing file send/receive by wireless connection

Symbol (page symbol) representing file storage or download

In/Out

(These options are used to set the format in which the recording device 110, 120 will record files, to activate storage or playback via headphones of recorded files and to activate sending and receiving of files to/from other devices or equipment.)

The GUI 500 further provides a volume level indicator 535, an equalisation indicator 540 and a battery charge indicator 545 which could each flash when in use. The function of the battery charge indicator 545 is similar to that for example as provided on a mobile telephone.

The GUI 500 may be implemented in any display technology and may or may not include back-lighting. Display technology of suitable type is known for example for use with mobile telephones and personal digital assistants. The GUI 500 may be provided for example as a liquid crystal display or touch sensitive screen. It may appear blank except for functions which have been activated by use of the associated keys 505, 510, 515. That is, all icons can be invisible unless called on. The keys themselves may also be incorporated into, and activatable by touching, the display of the GUI 500.

As well as the key menus described above, there may be sub-menus which appear on selection of a menu item. For example, selection of one of the format options “.WAV” or “.MP3” might bring up a “Save/Save As” option and selection of “Save As” may then offer “Filename?” To enter a file name, it must generally be possible to enter alphanumeric digits and this might be done by providing a keypad of the type known in mobile telephone technology, or selection could be made from digits shown on screen in the manner of a Web-based (that is, Internet) alphabetical interface.

Regarding the equalisation (“EQ”) indicator 540, this concerns a known processing technique that can be applied to reduce extraneous noise. Each instrument will generally have its own fundamental, characteristic frequency range. The EQ facility, sometimes known as “soft limiting”, is there to “clip” unwanted microphone background noise/hum etc, evident at frequencies outside the instrument's own fundamental range. This technique can also be used to change the tonal quality in a reproduction of the instrument when recording in a range away from its fundamental peak. To use the equalisation function, it is possible to access it via for example the “REC” command button 510. By selecting the “x 100” text, a sub-menu can be brought up offering the numbers 1 to 9 so as to select a clipped frequency range from 100 to 900 Hz. By selecting the “x 1k” text, a sub-menu can be brought up offering the numbers 1 to 3 so as to select a frequency range from 1 to 3 KHz. A required Hz setting can then be finalised by a double press of the “REC” command button 510.

An example of a particular beneficial use of an EQ facility is a violin. In this case, it can be used to reduce bow noise by reducing the low frequencies, for example under 200 Hz.

Regarding the volume level indicator 535, in “REC” mode and when “In” has been selected via the “FILE” button 505, this denotes the instrument's own volume setting, for example the volume control knob on an electric guitar 100. When “Out” has been selected via the “FILE” button 505, this denotes the headphone setting for playback function,

Jack Plug 120, Mounting

Referring to FIGS. 6 to 8, the jack plug 120 is mounted to be retractable into the side of the body 110 of the recording device. FIGS. 7a and 7b show a hinged mounting based on a cylindrical drum and FIGS. 8a and 8b show a ball and socket mounting. These types of hinged mounting are known and thus not described here in great detail.

Referring to FIGS. 7a and 7b, a first mounting is based on a drum 700 with conduits 705 through it to carry leads 710 (only one shown in FIG. 7a) to the microphone 915 and jack plug contacts 905, 945 (further described below in relation to FIG. 9). Rotation of the drum 700 allows the jack plug 120 to be stowed in a recess 715 in the body 110 of the recording device when not in use, without putting strain on the leads 710. In this respect, it might be preferred to use slightly overlong leads 710 to avoid any strain in general use of the device. Alternatively, it would be possible to use leads with a degree of extendibility such as a coiled section.

Optional features might be for example that stowing of the jack plug 120 switches the recording device 110, 120 off, and resilient retention of the jack plug 120 in its closed and open positions. Preferably, a button or flap might also be provided so that the stowed jack plug 120 can be easily flipped into its open, or “on”, position. It might be noted that the body 110 of the recording device at the back of the recess 715 provides an integral stop against which the jack plug 120 rests in its open position.

Thus the jack plug 120, and the jack plug's integral microphone 915 may be wired through a mechanical structure which serves as both the fulcrum for the rotation of the jack plug 120 and to provide bend protection for the wires 710.

Referring to FIGS. 8a and 8b, in an alternative arrangement, the jack plug 120 is mounted on the body 110 of the recording device by means of a ball and socket mounting, in the manner of a radio aerial, giving it more degrees of freedom in use In this embodiment, the jack plug 120 can be swung through an arc 805 around the top of the device, allowing a significant range of positions of the jack plug 120 relative to the body 110. Referring particularly to the cross section of FIG. 8b, the jack plug 120 is rigidly attached to a hollow ball 810 which is mounted over a smaller hollow ball 815 which is attached to the body 110 of the device via a short hollow stem 825. The two balls can rotate in relation to one another. The wires 710 of the jack plug 120 and microphone pass through an aperture 820 in the smaller ball 815 and out through its stem 825.

Jack Plug Construction

Referring to FIG. 9, the recording device incorporates both a conventional audio jack plug with contacts for connection to the pickup transducers mentioned above and, located within the jack plug structure itself, a microphone 915. The digital recording device 110, 120 may benefit from the location of the microphone 915 in the jack plug 120 such that the proximity of the microphone 915 to the sound creating element(s) of the musical instrument enhances the ability of the microphone 915 to detect the sound created by the musical instrument. Furthermore, the location of the microphone 915 may serve to render it less susceptible to the detection of extraneous ambient noise, which is external to the musical instrument. Thus the positioning of the microphone 915 may result in a particularly efficient means of detecting the sound of the musical instrument 100 while minimising the intrusion of background noise.

A microphone that might be used in this context is from the FG series supplied by Knowles Acoustics, owned by Knowles Electronics LLC, such as the FG-23629-P16. This is a very small but rugged electret microphone which needs only about 1.3 volts while having high sensitivity and low noise characteristics.

In more detail, the jack plug 120 has a housing which is in three conductive sections, separated by two insulating rings 910, 925. A first conductive section is the tip 900 which might be as found in a known form of jack plug or might be shaped differently, for example to reduce stresses. The tip 900 has a diameter of 6.3 mm in order to make contact in known manner with one of the jack plug socket contacts 300 in the instrument 100.

Also in known manner, this tip 900 might provide for example a positive contact to one or more existing pickups of an instrument and might be soldered to the next conductive section 935 of the housing by using a conductive alloy in place of the first insulating ring 910, or indeed simply be mounted by means of a “push fit” arrangement onto the next conductive section 935. Alternatively, the tip 900 may provide contact to pickups representing a left channel in a stereo electric guitar arrangement while the next conductive section 935 of the housing may provide contact to pickups representing a right channel. In this case, the tip 900 might be attached to the next conductive section 935 of the housing by an insulating material, such as a non-conductive epoxy material, providing the first insulating ring 910.

The tip 900 delivers its electrical signal via a central rod 905 which is modified from known jack plugs by being shortened to a length of 4 mm. This central rod 905 has a diameter of 2.5 mm and has an insulated connecting wire 940 attached to it to deliver signals through the housing of the jack plug 120.

The next conductive section 935 of the housing has apertures 920 in it. These might be created for example by cutting or by using a conductive mesh in constructing this section 935 of the housing. An omnidirectional condensing microphone 915 is mounted in this next conductive section 935 of the housing, adjacent the apertures 920 which allow airborne sound signals to reach the microphone 915. The microphone 915 is mounted on a conductive cable 950 for delivery of signals therefrom and can be supported by a silicon (or other insulating) packing material (not shown) that can be injected around the cable 950 near the microphone 915 in the housing. Preferably the apertures give the microphone substantially all round acoustic reception without intervening structure in as close to an omnidirectional manner as possible. For example, the apertures might be at least as long as the microphone in the longitudinal direction of the jack plug, preferably at least twice as long, while totalling for example at least 75% of a circumferential arc about it, or more preferably 80% or 90%.

The next conductive section 945 of the housing is provided by a conductive pole of 6.3 mm diameter, again as in known jack plugs but in this case hollowed out to accommodate the microphone 915 and the insulated connecting wire 940 from the tip 900. The conductive material of the pole might be for example brass or a nickel or copper alloy. This next conductive section 945 provides a negative contact to the one or more existing pickups of the instrument 100, in known manner, which is delivered to the body 110 of the recording device via a further connecting wire 930.

Overall, the jack plug 120 is based on a known inverting/non-inverting design connected as normal via contacts 300 to the pickup(s) of the instrument 100. It may act as both a conventional three conductor jack plug, i.e. stereo, left/right channel separation for electric, solid bodied guitars, or, independently, as a transducer microphone device for electro-acoustic guitars. Resulting analogue wave signals are delivered to the body 110 of the device where they are converted by an integrated analogue to digital converter (“ADC”) into digital binary code. The digitised wave signals are amplified and can then be stored within the device's integrated flash memory architecture for later retrieval via the integral USB connector 125. The jack plug 120 may facilitate audio left/right, stereo/mono separation and the microphone 915 picks up the varying sound pressures produced by the striking of, for example, guitar string(s), in use, to produce real-time varying current, of the order of micro-amperes (“μμA”).

In a method of making a jack plug 120 as described above, the components of a known form of coaxial style jack plug need to be modified to provide a bore of 3.6 mm diameter to accommodate the microphone 915 and its cable 950. A known microphone 915 suitable for use in this embodiment of the invention, such as the Knowles microphone mentioned above, has a diameter of 2.6 mm and is supplied with a cable 950 of about 2 mm diameter. The insulating ring(s) 910, 925 also need to maintain a reasonable thickness, say of the order of 0.4 mm. Otherwise, and apart from reducing the length of the central contact rod 905 of the tip 900 to about 4 mm, the jack plug 120 in terms of its tip 900, housing 935, 945 and fittings may be designed to meet standardised “quarter inch” industry specifications.

Software

Referring to FIG. 10, the body 110 of the digital recording device houses primarily a microcontroller 1000, together with (or incorporating) an analogue to digital converter (“ADC”) 1005. When the jack plug 120 collects string or electromagnetic wave vibrations/signals via the pickups or microphone 915, the signals are amplified in amplifiers 1005 and then the ADC 1005 transforms the generated voltage signal into digital binary coded information. This process can be executed within the microcontroller 1000 using various sampling rates, such as 44.1 kHz, 48 kHz or 60 KHz, and different bits per sample, such as 16 bits, 24 bits or 32 bits.

In general, the microcontroller can support the functions that the keys 505, 510, 515 of the GUI need to run. Thus it provides a command processor in that it provides a combination of functions such as the “SETUP” functions 1070, “RECORD” functions 1075 and the “FILE” functions 1080. It also provides a digital signal processor in that it provides for example the “EQUALISER” function 1085. Lastly, it will support or interface to communications processes 1060 for use when inputting or outputting audio files 1050 by appropriate technologies such as Bluetooth 1055.

The microcontroller 1000 may be for example the AT91 SAM9260 supplied by the Atmel Corporation. This is based on the integration of an ARM926EJ-S processor with fast ROM and RAM memories and various peripherals. It offers ethernet connection and a USB device port and host controller. It can also, in known manner, support wireless communication such as Bluetooth (registered trade mark) 1025, tuning 1065, and further amplification if required.

The microcontroller 1000 can convert incoming signals to .WAV and/or .MP3 file formats, performing either analogue or digital signal processing as necessary and store the files 1050 in a data store 1045, either separate from or integral to the microcontroller 1000. These files 1050 can then later be transferred via the USB plug 125 of the digital recording device onto a PC 1040 or MP3 player. These files 1050 can be sent either directly onto an MP3 player, or to a music recording programme, such as one running Steinberg Cubase ®/Cakewalk® software for editing etc. Alternatively, the files 1050 can be sent wirelessly to another device 110 of similar type, or to any compatible Bluetooth equipment such as a mobile telephone.

An option is for the user either to listen to material being recorded, by use of headphones 1030 plugged into the headphone socket 525, or to play back previously recorded files 1050 from the data store 1045. Depending on the nature of the headphones, it may also be necessary to connect the headphones via a digital to analogue converter. A suitable component is a low power stereo codec with headphone amplifier supplied by Cirrus Logic Incorporated with the product code CS 42L51. This provides both analogue to digital and digital to analogue conversion including many features, such as 3:1 stereo input multiplexing, programmable gain amplification, stereo microphone pre-amplification, automatic level control, and a digital signal processing engine.

Wireless Communication

A feature of embodiments of the invention that offers great versatility is the wireless transmission and receipt of audio files. This can be done using a Bluetooth capability 1025 via an additional port of the microcontroller 1000, and by selection using the file key 505. Bluetooth is now a widely used industrial specification for short range exchange of information using radio frequencies. The Bluetooth specifications are developed and licensed by the Bluetooth Special Interest Group (“BSIG”) and are designed to be low cost and of low power consumption. There are currently three classes, each having a different range. Class 1 has a range of about 100 m, Class 2 a range of about 10 m and Class 1 has a range of about 1 m. Being radio, the devices do not have to be in line of sight.

In order to use Bluetooth, a device must be compatible with at least one Bluetooth profile and a profile likely to be found appropriate in embodiments of the present invention is the Advanced Audio Distribution Profile (“A2DP”) which defines how audio can be streamed over a Bluetooth connection.

Example of Use

An example of using an embodiment of the invention for basic recording and file transfer is as follows.
operate power button ‘ON’ (or bring jack plug 120 out of stowed position, or press “REC” key 510)
use arrow portion of “SETUP” button 515 to scroll the sub-menu ‘saddle’/‘solid’/‘mic’/‘E/Acoustic’
select using the “SETUP” button 515
use arrow portion of “REC” button 510 to scroll the REC command sub-menu
select the LED, using the “REC” button 510, to activate the recording function. The LED will now flash continuously
plug the digital recording device 110, 120 into the jack plug socket 105 of an instrument 100. The device will now record and the active counter next to the start symbol will start to count
when finished, unplug the digital recording device 110, 120 from the jack plug socket 105
use arrow portion of “REC” button 510 to scroll the REC command sub-menu
select the stop symbol, using the “REC” button 510, to stop the recording function (or stow the jack plug 120)
use arrow portion of “FILE” button 505 to scroll the FILE command sub-menu
select the In/Out symbol, using the “FILE” button 505, to confirm file storage
scroll and select “.WAV”, which brings up a submenu giving “Save”/“Save As” options
select the “Save” option which now brings up “Enter Filename?”
enter a file name
confirm the file name using the “FILE” button 505

Although not shown in FIG. 5, a file name can be entered, as mentioned above, either by provision of a keypad of the type used in mobile telephone technology or by scrolling and selecting from an alphabet as often seen on public internet index pages.

At a later time, it is then possible to connect the digital recording device 120, 110 by means of the USB plug 125 to equipment carrying for example WAV or MP3 based software in order to download or import recorded files 1050 from the data store 1045 of the device. Alternatively of course, it is also possible to use the file key 505 to select wireless communication of recorded files 1050 to other devices.

Other Features and Variations

Other options that might be provided by embodiments of the digital recording device 120, 110 include a metronome feature that may be heard by means of the headphones 1030, an option for use of either rechargeable batteries (recharged in known manner through connection by the USB plug 125) or direct power when so connected, and other case sizes and shapes depending on the functionality required. It is also possible to use the device to record other sources of electronic, magnetic or acoustic signals. These may include, but are not limited to, other stringed and non-stringed musical instruments, industrial transducers (for example temperature or pressure measurement), and recreational or sports transducers (for example heart rate monitors). To the extent that the device carries a microphone 915, it can also be used to pick up sound produced by non-electric instruments, voice or any other sound sources.

It will be understood that .WAV and .mp3 are not the only formats developed for audio files and other formats may be supported by embodiments of the invention as well or instead.

Embodiments of the device are described above as portable and suitable for mounting on a guitar for example. Indeed, the approximate dimensions of the body portion 110 are as small as those of a flash memory stick (registered trade mark), being less than 10 cms in length and less than 3 cm wide. The weight, including a battery, is only a few grams, perhaps less than 20 grams.

Embodiments of the invention can be mounted on an instrument entirely by means of the jack plug. Using a jack plug 120 with for example a resilient mounting, or more particularly a hinged mounting such as that shown in FIGS. 7 and 8 and described above, embodiments of the invention can be designed to be particularly suitable for mounting into the jack socket recess 200 of a Fender Stratocaster guitar so that there is little protuberance to interfere with use of the guitar. Further, embodiments of the invention can be entirely independent of any connecting or interconnecting cabling in use, for example either to record audio material in digital or analogue form or, by using known wireless technology such as Bluetooth or infra red connection, to transfer audio material to or from external software-based devices or apparatus.

1. An instrument recording device adapted to be supported by an instrument during use, the device comprising: i) a microphone for receiving sounds made by the instrument; ii) an analogue to digital converter for converting received sounds into a digital signal; iii) digital signal storage for storing the digital signal; and iv) at least one output for outputting stored digital signals from the device, the device further comprising a mounting arrangement for use in mounting the device on the instrument during use, the mounting arrangement housing the microphone.

2. A device according to claim 1 wherein the microphone is an omnidirectional microphone.

3. A device according to claim 1 wherein the mounting arrangement comprises an electrical plug for mounting in a socket of an electric instrument.

4. A device according to claim 3 wherein the plug comprises a jack plug.

5. A device according to claim 1 wherein the mounting arrangement comprises a generally tubular structure housing the microphone.

6. A device according to claim 5 wherein said tubular structure has apertures adjacent the microphone to give substantially all round acoustic reception.

7. A device according to claim 5 wherein the outer surface of the tubular structure is at least partially conductive so as to transmit electrical signals.

8. A device according to claim 1 wherein the instrument comprises a musical instrument.

9. A device according to claim 1 wherein the at least one output comprises a wireless output.

10. A device according to any claim 1 wherein the at least one output comprises a speaker and/or headphone socket for playback.

11. A device according to claim 1, further comprising a wireless input for receipt of audio files.

12. A device according to claim 1, further comprising a user interface.

13. A device according to claim 1, further comprising a digital signal processor.

14. A device according to claim 13, further comprising an analogue to digital signal converter.

15. A device according to claim 1, further comprising a coding device for coding digital signals in a format suitable for storing audio files.

16. A device according to claim 15 wherein the coding device is adapted to code digital signals in .WAV and/or .MP3 format.

17. A device according claim 1, wherein the at least one output comprises a USB connector.

18. A device according to any claim 1, the device comprising the mounting arrangement and a body portion, the body portion having a length of less than 10 cms.

19. A device according to claim 18 wherein the body portion has a height of less than 3 cms.

20. A device according to claim 18, the mounting arrangement of the device comprising a jack plug for insertion into a jack socket of an instrument having a jack socket recess, the body portion of the device being adapted, in use of the device, to be at least partially received into and supported by said jack socket recess.

21. An instrument recording device adapted to be mounted on an instrument during use, the device comprising: i) an input for receiving sounds made by the instrument; ii) an analogue to digital converter for converting received sounds into a digital signal; iii) digital signal storage for storing the digital signal; iv) at least one output for outputting stored digital signals from the device; v) a user interface; and vi) a command processor for implementing commands input by a user via the interface wherein the at least one output comprises a wireless output and the arrangement is such that the interface and command processor support wireless transmission of a stored digital signal, from the device.

22. A device according to claim 21 wherein the input comprises a jack plug for receiving electromagnetic signals from a pickup already present on the instrument.

23. A device according to claim 22 wherein the input comprises a microphone for receiving audio signals from the instrument.
